(19) United States
(12) Patent Application Publication
(10) Pub. No.: US 2026/0237025 A1
(43) Pub. Date: Aug. 13, 2026

(54) ADAPTIVE COLOR TUNE TRANSFORMATION LOSS FOR ENHANCED SENSITIVITY IN GENERATIVE MODELS

(71) Applicant: Adobe Inc., San Jose, CA (US)

(72) Inventors: Haitian Zheng, Rochester, NY (US); Jianming Zhang, Campbell, CA (US); Jingwan Lu, Santa Clara, CA (US); Sohrab Amirghodsi, Seattle, WA (US); Yuqian Zhou, Seattle, WA (US); Zhe Lin, Fremont, CA (US)

(21) Appl. No.: 19/049,830

(22) Filed: Feb. 10, 2025

(51) Int. Cl. G06T 5/60; G06T 5/50; G06T 5/77; G06T 11/00

(52) U.S. Cl. CPC G06T 5/60; G06T 5/50; G06T 5/77; G06T 11/10; G06T 2207/10024; G06T 2207/20081; G06T 2207/20084

(57) ABSTRACT

The present disclosure relates to systems, methods, and non-transitory computer-readable media that modifies parameters of a generative model based on enhancing pixels of images. Furthermore, the disclosed systems generate a modified digital image from a digital image by inpainting a region of the digital image. Moreover, the disclosed systems generate a first measure of loss based on comparing the modified digital image with a ground truth version of the digital image. Further, the disclosed systems generate a transformed modified digital image and a transformed ground truth image of the digital image by performing a color space transformation and further generates a second measure of loss. From the first measure of loss and the second measure of loss, the disclosed systems modify parameters of a generative model.

### BACKGROUND

Recent years have seen significant advancement in hardware and software platforms for performing generative tasks. Indeed, systems provide a variety of ways to train generative models for learning generative tasks. For instance, systems train generative models to perform inpainting tasks. Despite the advances in training generative models to perform inpainting tasks, systems suffer from a number of deficiencies with regards to accuracy and efficiency.

### SUMMARY

One or more embodiments described herein provide benefits and/or solve one or more problems in the art with systems, methods, and non-transitory computer-readable media that improve the fidelity digital media produced by generative models with respect to subtle color and texture artifacts. Specifically, the disclosed systems utilize an adaptive color tune transformation loss that refines the perceptual quality of images generated by generative models (e.g., generative adversarial network). To illustrate, in one or more embodiments, disclosed systems generate a modified digital image by inpainting a region of a digital image. Moreover, the disclosed systems further generate a transformed modified digital image and a transformed ground truth image by performing a color space transformation on the modified digital image and the ground truth version of the digital image. For instance, the disclosed systems use a color space transformation to map pixel values of the modified digital image and the ground truth version of the digital image to new pixel values. The transformed images have enhanced pixel values that capture subtle and nuanced differences between a modified digital image (e.g., with inpainted pixels) and a ground truth version of the digital image. Furthermore, the disclosed systems generate a measure of loss by comparing the transformed modified digital image with the transformed ground truth image. In one or more embodiments, the disclosed systems modify parameters of the generative based on the measure of loss.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a color space enhancement system operates in accordance with one or more implementations;

FIG. 2 illustrates an overview of the color space enhancement system using a color space transformation to modify parameters of a generative model in accordance with one or more implementations;

FIG. 3 illustrates an example diagram of the color space enhancement system generating an amplified version of a modified digital image in accordance with one or more implementations;

FIG. 4 illustrates an example diagram of the color space enhancement system sampling pixel values from a modified digital image and an amplified version of the modified digital image in accordance with one or more implementations;

FIG. 5 illustrates an example diagrams of the color space enhancement system using a color tune mapping function to generate a transformed version of a modified digital image and a transformed version of a ground truth image in accordance with one or more implementations;

FIG. 6 illustrates an example diagram of the color space enhancement system generating various measures of loss to modify parameters of a generative model in accordance with one or more implementations;

FIG. 7A illustrates an example diagram of the color space enhancement system generating an inpainted digital image at inference time in accordance with one or more implementations;

FIGS. 7B-7D illustrate graphical user interface illustrating the user experience associated with generating an inpainted digital image at inference time as shown with respect to FIG. 7A in accordance with one or more implementations;

FIG. 8 illustrates results of the color space enhancement system generating an enhanced modified digital image and an enhanced ground truth image in accordance with one or more implementations;

FIG. 9 illustrates a schematic diagram of the color space enhancement system in accordance with one or more implementations;

FIG. 10 illustrates a flowchart of a series of acts for modifying parameters of a generative model in accordance with one or more implementations;

FIG. 11 illustrates a block diagram of an exemplary computing device in accordance with one or more implementations.

### DETAILED DESCRIPTION

One or more embodiments described herein includes color space enhancement system that leverages a unique adaptive color tune transformation loss for enhanced sensitivity (e.g., for subtle color differences) in optimizing generative models (e.g., generative adversarial neural networks, hereinafter referred to as “GAN”). The color space enhancement system implements a unique adaptive color tune transformation loss, which during training, dynamically adjusts a color-space based on an output (e.g., a modified digital image with inpainted pixels) and ground truth image content. Specifically, the color space enhancement system uses a color tune mapping function to adjust the color space of a generated digital image and a ground truth image. The color space enhancement system uses the adjusted images as part of the adaptive color tune transformation loss to train the generative model.

As part of the color tune mapping function, the color space enhancement system amplifies important but subtle perceptual differences, which better captures (e.g., relative to existing systems) how to generate inpainted pixels to replace a region. In other words, the color space enhancement system improves (e.g., relative to existing systems) a learning process for performing generative inpainting tasks (e.g., by more accurately modifying parameters of a GAN). In particular, the color space enhancement system optimizes parameters of a GAN to more effectively generate inpainting pixels without inpainting artifacts (e.g., or a reduced number of inpainting artifacts relative to existing systems).

In one or more embodiments, the color space enhancement system uses the color space transformation to generate an amplified version of a modified digital image (e.g., an image with inpainted pixels). Specifically, the color space enhancement system uses the amplified version to further determine/generate a color tune mapping function, which is used to map a modified digital image and a ground truth version of the digital image to new pixel values. For instance, the color space enhancement system generates the amplified version of the digital image by enhancing the difference in pixel values between the modified digital image and the ground truth version of the digital image by a preset amount (e.g., a beta value). Furthermore, from sampled pixel values of the amplified version and the modified digital image, the color space enhancement system determines a color tune mapping function.

In one or more embodiments, the color space enhancement system determines a measure of loss between a generated digital image (e.g., modified digital image, relative to a digital image) and a ground truth version of a digital image (e.g., with a completed region). Specifically, the color space enhancement system transforms the modified digital image and a ground truth version of the digital image according to a color space transformation (e.g., the color tune mapping function) to further enhance subtle differences in the modified digital image and the ground truth version of the digital image. The color space enhancement system trains a generative model using a measure of loss based on the transformed version of digital images, which enhances the accuracy of capturing subtle nuance and details while performing generative inpainting tasks.

At implementation time, the color space enhancement system leverages a trained generative model (e.g., a GAN) which is trained to avoid/reduce generating inpainting artifacts (e.g., based on the measures of loss determined using the adaptive color tune transformation loss). Specifically, due to the color space enhancement system training the generative model using a color space transformation (e.g., tuned with the color tune mapping function), the color space enhancement system generates inpainted digital images at a higher quality relative to existing generative methods.

As mentioned above, existing systems suffer from a number of issues relating to computational accuracy and efficiency. For example, for generative inpainting tasks, existing systems train generative models using loss measures, such as L1 and a perceptual loss. For instance, these conventional loss measures (e.g., such as L1 and a perceptual loss) fail to capture subtle color and texture differences and often result in trained models that generate images that lack fine detail and perceptual accuracy (e.g., especially for applications such as high-quality inpainting image generation). Often, existing systems perform generative tasks and generate images that contain color shifts, subtle texture pattern mismatches, and other artifacts that make the generated digital image look distorted.

In other words, existing systems that use conventional loss measures (e.g., such as L1 and perceptual loss) may capture broad features but often miss nuanced differences that are important for generating accurate and high-quality digital images. Thus, existing systems that perform generative tasks often fail to match the precise color and texture portrayed in real-world digital images. Despite existing systems making many advances in performing generative tasks at a high level, the human eye is highly sensitive to the subtle and nuanced differences that existing systems fail to capture. Thus, existing systems often generate inpainted pixels that appear distorted or inaccurate to user, particularly upon careful inspection.

Moreover, in some embodiments, existing systems often suffer from inefficiencies when generating inpainted pixels. Specifically, existing systems typically require additional inputs, processing, and feedback at implementation time (e.g., due to the inaccurate training methods discussed above). For example, because existing systems typically generate a sub-par result for a digital image, existing systems also often receive additional inputs to further edit a digital image to address the generated artifacts. Thus, existing systems at implementation time consume additional time and computational resources in attempts to fix artifacts created by generated inpainted pixels.

In one or more embodiments, the color space enhancement system provides several improvements over existing systems in relation to accuracy and efficiency. In contrast to existing systems that fail to capture subtle color and texture differences, the color space enhancement system captures the subtle color and texture differences by using a color tune mapping function. For instance, the color space enhancement system generates a transformed modified digital image and a transformed ground truth image that emphasize/highlight color differences between a modified digital image and a ground truth version of the digital image. Moreover, the color space enhancement system leverages the emphasized/highlighted color differences to further inform the generative model on how to avoid/reduce generating inpainting artifacts while generating inpainted pixels.

As mentioned above, existing systems often generate digital images with inpainting artifacts (e.g., color shifts, subtle texture pattern mismatches), however the color space enhancement system trains a generative model to avoid these issues by accounting for the subtle details and nuances between a modified digital image with inpainted pixels and a ground truth image. In particular, the color space enhancement system generates an amplified version of the modified digital image with inpainted pixels that indicates a color difference between the inpainted pixels and a ground truth version of the digital image. The color space enhancement system further uses the amplified version to generate a color tune mapping function (e.g., which is used to train a generative model to accurately avoid generating inpainting artifacts). Thus, relative to existing systems, the color space enhancement system generates inpainted pixels that appear consistent and accurate with the rest of a digital image.

Moreover, in one or more embodiments, the color space transformation system improves upon computational efficiency of existing systems. In contrast to existing systems which typically require additional inputs after generating inpainted pixels to correct artifacts, the color space enhancement system generates a satisfactory image with inpainted pixels without requiring a user to prompt and re-prompt the system to fix artifacts. In particular, as mentioned above, the color space enhancement system fine-tunes a generative model to avoid the generation of inpainted pixels that create artifacts (e.g., generates digital images with inpainted pixels that are accurate and consistent with the remainder of the digital image). As such, the color space enhancement system more efficiently performs generative tasks, such as inpainting.

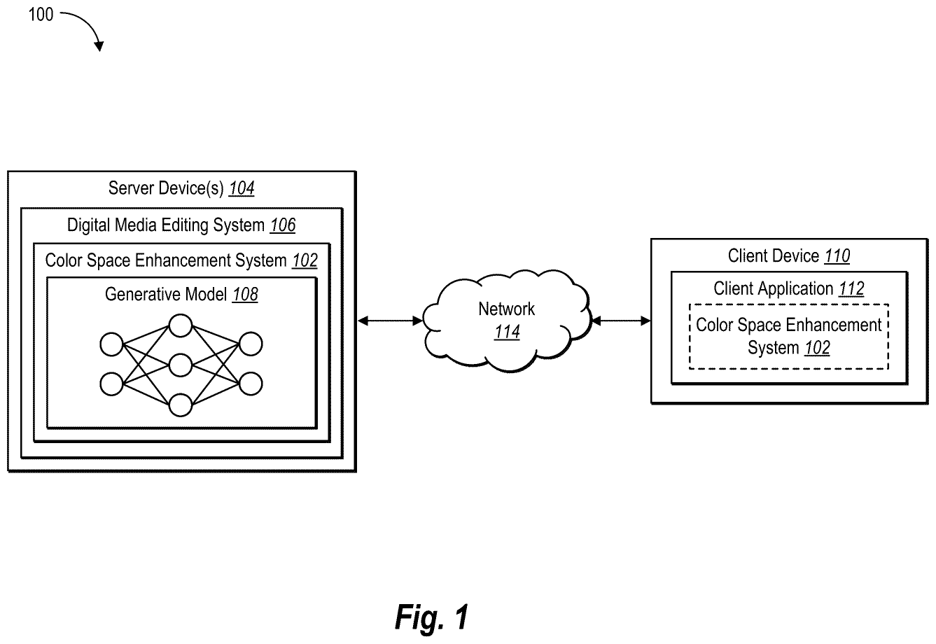

Additional details regarding the color space enhancement system will now be provided with reference to the figures. For example, FIG. 1 illustrates a schematic diagram of an exemplary system environment 100 in which a color space enhancement system 102 operates. As illustrated in FIG. 1, the system environment 100 includes server device(s) 104, a digital media editing system 106, a network 114, and a client device 110. Additionally, FIG. 1 illustrates that the digital media editing system 106 includes the color space enhancement system 102, which includes a generative model 108. Moreover, the client device 110 includes a client application 112 (e.g., a client side digital media editing application).

Although the system environment 100 of FIG. 1 is depicted as having a particular number of components, the system environment 100 is capable of having a different number of additional or alternative components (e.g., a different number of server devices, client devices, or other components in communication with the color space enhancement system 102 via the network 114). Similarly, although FIG. 1 illustrates a particular arrangement of the server device(s) 104, the network 114, and the client device 110, various additional arrangements are possible.

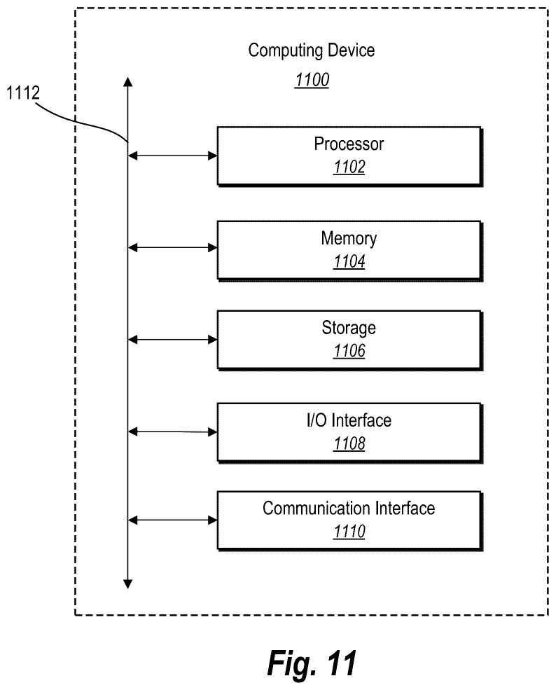

The server device(s) 104 and the client device 110 are communicatively coupled with each other either directly or indirectly (e.g., through the network 114 discussed in greater detail below in relation to FIG. 11). Moreover, the server device(s) 104 and the client device 110 include one or more of a variety of computing devices (including one or more computing devices as discussed in greater detail in relation to FIG. 11).

As mentioned above, the system environment 100 includes the server device(s) 104. In one or more embodiments, the server device(s) 104 process input for generating inpainted pixels in a digital image (e.g., by employing one or more models such as the generative model 108). In one or more embodiments, the server device(s) 104 comprise a data server. In some implementations, the server device(s) 104 comprise a communication server or a web-hosting server.

In some embodiments, the client device 110 is associated with the one or more user accounts that submit requests to generate inpainted digital images. In one or more embodiments, the client device 110 includes smartphones, tablets, desktop computers, laptop computers, head-mounted-display devices, or other electronic devices. The client device 110 includes one or more software applications (e.g., the client application 112) for generating or modifying digital images in accordance with the digital media editing system 106. In one or more embodiments, the client application 112 includes a software application hosted on the server device(s) 104 accessible by the client device 110 through another application, such as a web browser.

To provide an example implementation, in some embodiments, the digital media editing system 106 on the server device(s) 104 supports the client application 112 on the client device 110. For instance, in some cases, the color space enhancement system 102 on the server device(s) 104 trains the generative model 108 utilizing an adaptive color tune transformation loss. In response, the color space enhancement system 102, via the server device(s) 104, provides the trained generative model 108 to the client device 110. In other words, the client device 110 obtains (e.g., downloads) a generative model 108 from the server device(s) 104 that is already trained/optimized utilizing an adaptive color tune transformation loss. Once downloaded, the generative model 108 on the client device 110 is able to perform generative tasks (e.g., inpainting tasks that generate pixels that are consistent with the texture and details of the remainder of the digital image) independent from the server device(s) 104. In one or more alternative implementations, the color space enhancement system 102 generates or learns parameters for the generative model 108 in whole or in part on the client device 110.

In alternative implementations, the digital media editing system 106 includes a web hosting application that allows the client device 110 to interact with content and services hosted on the server device(s) 104. To illustrate, in one or more implementations, the client device 110 accesses a software application supported by the server device(s) 104. In response, the digital media editing system 106 on the server device(s) 104 provides tools for performing image inpainting or other image editing or creation tasks. In other words, the client device 110 does not have to download the color space enhancement system 102 or generative model 108 while still being able to access/utilize the trained/optimized tools provided by the digital media editing system 106 via a web hosting application.

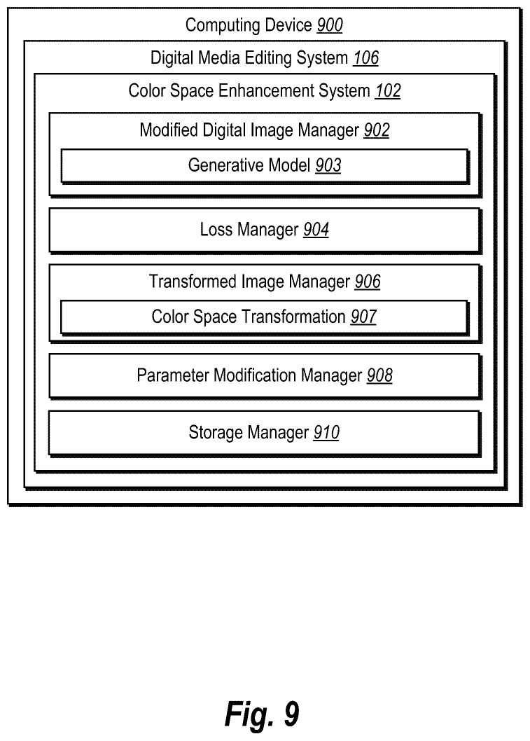

In some embodiments, the color space enhancement system 102 is implemented in whole, or in part, by the individual elements of the system environment 100. For instance, although FIG. 1 illustrates the color space enhancement system 102 implemented or hosted on the server device(s) 104, different components of the color space enhancement system 102 are able to be implemented by a variety of devices within the system environment 100. For example, one or more (or all) components of the color space enhancement system 102 are implemented by a different computing device or a separate server from the server device(s) 104. Indeed, as shown in FIG. 1, the client device 110 includes the color space enhancement system 102. Example components of the color space enhancement system 102 will be described below with regard to FIG. 9.

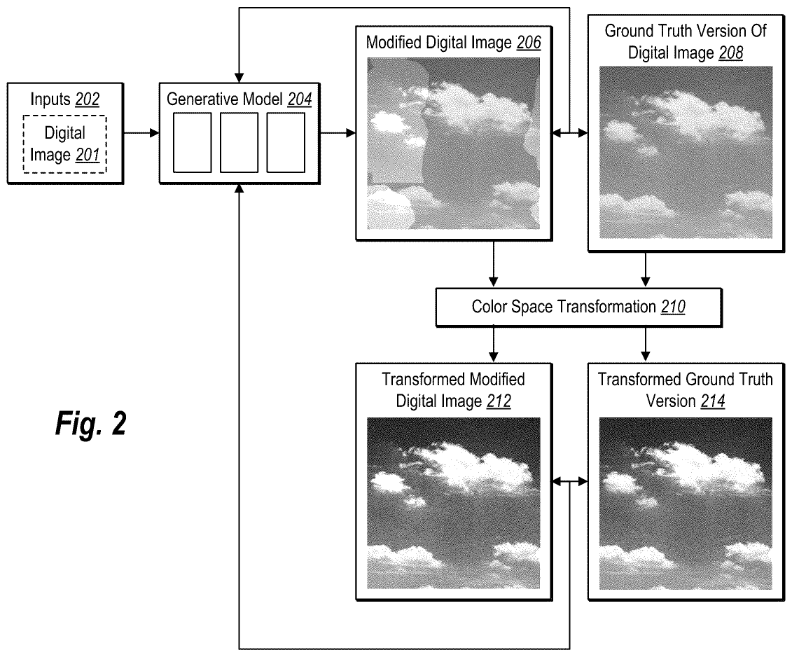

As mentioned above, in certain embodiments, the color space enhancement system 102 utilizes an adaptive color tune transformation loss to modify parameters of a generative model to train the generative model to avoid/reduce generating inpainting artifacts. FIG. 2 illustrates the color space enhancement system 102 generating a transformed version of a modified digital image and a transformed version of a ground truth image using a color space transformation in accordance with one or more embodiments.

FIG. 2 illustrates the color space enhancement system 102 receiving inputs 202, where the inputs 202 further includes a digital image 201. In particular, in some embodiments, the inputs 202 further include instructions or a mask indicating a region in the digital image to modify (e.g., inpaint). In one or more embodiments, the color space enhancement system 102 receives or accesses the digital image 201. For example, the digital image 201 includes a digital frame composed of various pictorial elements. In particular, the pictorial elements include pixel values that define the spatial and visual aspects of the digital image 201. Furthermore, the color space enhancement system 102 receives digital images from various platforms. Moreover, in some embodiments, the digital image 201 does not include inpainted pixel values (e.g., the pixel values of the digital image are unpainted).

Moreover, FIG. 2 shows the color space enhancement system 102 using a machine learning model (e.g., a generative model 204) to process the inputs 202 (e.g., the digital image 201) and generate a modified digital image 206. In one or more embodiments a machine learning model includes a computer algorithm or a collection of computer algorithms that is trainable and/or tunable based on inputs to approximate unknown functions. For example, a machine learning model includes a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, or a multi-layer perceptron. In some embodiments, a neural network includes a combination of neural networks or neural network components.

As shown in FIG. 2, the color space enhancement system 102 uses the generative model 204, which in some embodiments is a GAN. In one or more embodiments, the GAN comprises two machine learning models that compete with each other in a zero-sum game. To illustrate, the generative aspect of the GAN generates data (e.g., pixels) for which a discriminator makes an authenticity prediction of the generated feature. If the generative neural network manages to generate data in which the discriminator is unable to discriminate as unauthentic (e.g., tricks the discriminator), this is propagated back to the discriminator for modification of the discriminator's parameters. If the generative neural network is unable to “trick” the discriminator, then this is propagated back to the generative machine learning model for modification of the generative machine learning model's parameters. The color space enhancement system 102 trains the generative model 204 (e.g., the GAN) by using the competition between the generator and discriminator to improve the generative capabilities of the generator and further improves capabilities of the generative model 204 by using the color space transformation loss.

As shown in FIG. 2, the color space enhancement system 102 uses the generative model 204 to generate a modified digital image 206 from the digital image 201. In one or more embodiments, the modified digital image 206 refers to a digital image that has been changed, altered, or enhanced by the generative model 204. In particular, the modified digital image 206 refers to a digital image that includes one or more inpainted portions in place of one or more regions in a digital image. Specifically, the color space enhancement system 102 utilizes a generative inpainting model to replace one or more regions in the digital image 201 with inpainted portions.

Moreover, in some embodiments, the modified digital image 206 contains inpainting artifacts. Specifically, the modified digital image 206 contains inpainting artifacts around borders of one or more inpainted portions in the modified digital image. For instance, the color space enhancement system 102 generates the modified digital image 206 (using the generative model 204) to train/optimize the generative model to progressively learn to generate images without inpainting artifacts.

As mentioned above, the color space enhancement system 102 generates the modified digital image 206 (e.g., with inpainted pixels) from the digital image 201 (without inpainted pixels). Furthermore, in some embodiments, the color space enhancement system 102 accesses a ground truth version 208 of the digital image 201. In one or more embodiments, the ground truth version 208 of the digital image 201 refers to an image that is considered true or a reference image with one or more regions in the digital image 201 that is completed. Specifically, the ground truth version 208 of the digital image 201 refers to a digital image without inpainting artifacts and acts as a reference image for comparing to an inpainted digital image (e.g., the modified digital image 206). For instance, the ground truth version 208 of the digital image 201 represents an accurate or ideal state of a digital image 201 and the color space enhancement system 102 uses the ground truth version 208 of the digital image 201 to modify parameters of the generative model 204.

Furthermore, FIG. 2 illustrates the color space enhancement system 102 comparing the modified digital image 206 with the ground truth version 208 of the digital image 201. For instance, the color space enhancement system 102 compares the modified digital image 206 with the ground truth version 208 of the digital image 201 to generate a measure of loss (e.g., a discriminator loss, a L1 loss, or a perceptual loss) as indicated by the top arrow returning to the generative model 204. In one or more embodiments, a measure of loss refers to a mathematical function that quantifies a difference between a generated output (e.g., generated by the generative model 204, such as a GAN) and a ground truth value. Specifically, a measure of loss provides a way to assess how well or poorly a generative model's predictions align with expected or ground truth values. Moreover, the color space enhancement system 102 uses the measure of loss to optimize/train a generative model to minimize a loss function, which leads to better performance for the generative model 204.

In one or more embodiments, the color space enhancement system 102 uses a color space transformation 210 to generate a color tune mapping function. Specifically, the color space enhancement system 102 uses a color space transformation that is specifically tailored for capturing/enhancing subtle and nuance differences between the modified digital image 206 and the ground truth version 208 of the digital image 201.

In one or more embodiments, the color space enhancement system 102 generates a color tune mapping function as part of the color space transformation 210 to aid in generating transformed versions of digital images. Specifically, a color tune mapping function refers to a mathematical or algorithmic process to map pixel values of a digital image to specific color values. For instance, the color space enhancement system 102 utilizes a color tune mapping function to enhance the underlying pixels by making the patterns in the digital image more visually distinguishable.

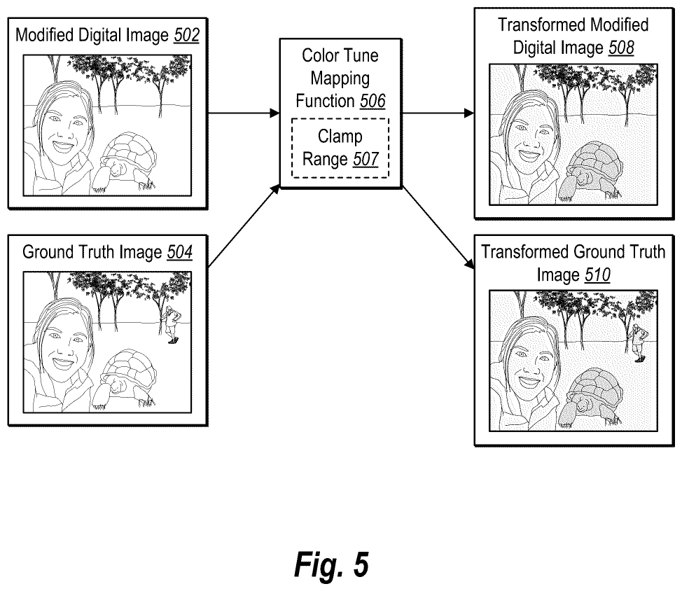

As shown in FIG. 2, the color space enhancement system 102 uses the color space transformation 210 to generate a transformed modified digital image 212 and a transformed ground truth image 214. In one or more embodiments, the color space enhancement system 102 generates multiple measures of loss to modify parameters of the generative model 204. For instance, as shown in FIG. 2, the color space enhancement system 102 generates a measure of loss (e.g., an adaptive color tune transformation loss) between the transformed modified digital image 212 and the transformed ground truth image 214 to modify parameters of the generative model 204. Additional details regarding generating the transformed versions of digital images are given below in the description of FIG. 5.

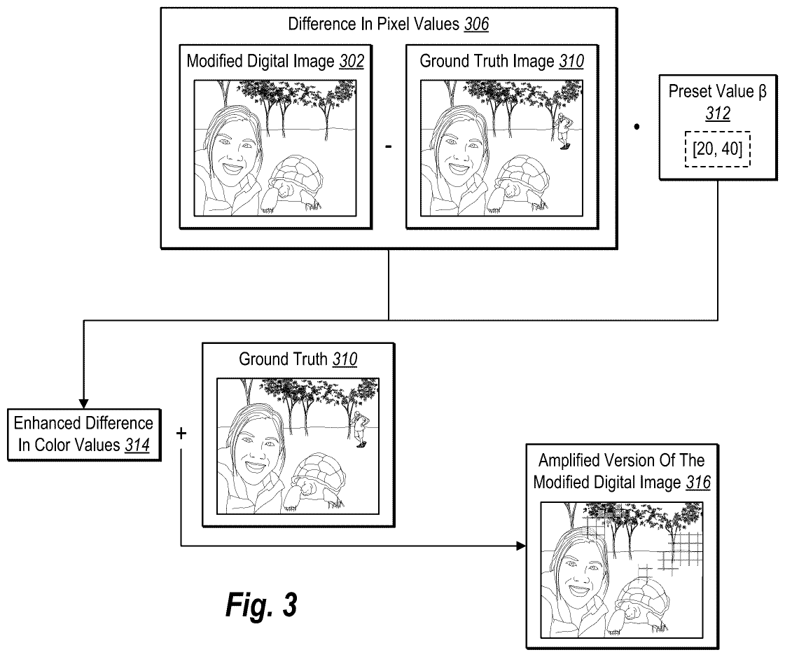

As mentioned above, the color space enhancement system 102 generates an amplified version of the modified digital image to aid in generating a color tune mapping function. FIG. 3 illustrates the color space enhancement system 102 generating an amplified version of the modified digital image based on enhanced differences in color values between the modified digital image and a ground truth version of a digital image in accordance with one or more embodiments.

As shown in FIG. 3, the color space enhancement system 102 accesses a modified digital image 302 after generating inpainting pixels to replace a region in a digital image. For instance, as illustrated in FIG. 3, a ground truth image 310 shows a person in the background of the digital image next to the trees, however, the modified digital image 302 shows the person in the background removed and replaced with inpainted pixels. In particular, the color space enhancement system 102 determines an infill modification to replace the person in the background.

As mentioned above, the color space enhancement system 102 determines an infill modification. For example, the infill modification includes inpainting modifications. In particular, the infill modification includes replacing pixel values in a region. For instance, for replacing pixel values, the color space enhancement system 102 replaces existing pixel values in a digital image with new pixel values. In other words, the infill modification modifies existing pixels within the digital image. Further, inpainting includes replacing/adjusting pixel values within a digital image. In particular, inpainting includes replacing/adjusting currently existing pixel values within the digital image.

As shown in FIG. 3, the color space enhancement system 102 generates an amplified version 316 of the modified digital image 302. Specifically, FIG. 3 shows the color space enhancement system 102 determines a determine a difference 306 in pixel values between the modified digital image 302 and a ground truth image 310.

Moreover, FIG. 3 shows the color space enhancement system 102 amplifying the difference 306 in pixel values by a preset value 312 (e.g., an enhancement factor). In one or more embodiments, the color space enhancement system 102 enhances the difference 306 in pixel values of the modified digital image 302 and the ground truth image 310 by beta. Specifically, beta refers to a preset value 312 that is confined within a preset range (e.g., FIG. 3 shows the preset range as between 20 and 40). To illustrate, the color space enhancement system 102 amplifies the color difference by a beta of 20.

As shown in FIG. 3, based on amplifying the difference 306 in pixel values between the modified digital image 302 and the ground truth image 310, the color space enhancement system 102 determines/generates an enhanced difference in color values 314. As shown, the color space enhancement system 102 further combines the enhanced difference in color values 314 with the ground truth image 310 to generate the amplified version 316 of the modified digital image 302. In particular, the amplified version 316 of the modified digital image 302 indicates an accentuated (e.g., enhanced) color difference between the modified digital image 302 and the ground truth image 310.

In doing so, the color space enhancement system 102 captures/amplifies subtle and nuanced differences between the modified digital image 302 and the ground truth image 310, such that the color space enhancement system 102 improves the training process of a generative model in learning to generate inpainted pixels without inpainting artifacts.

As shown in FIG. 3, the amplified version 316 of the digital image depicts a pattern over portions of the digital image. In particular, the pattern indicates pixel differences between the modified digital image 302 and the ground truth image 310 that are amplified by the preset value 312. For instance, the amplification of the difference 306 in pixel values shows an exaggerated or highlighted indication of the differences in the amplified version 316, thus allowing the color space enhancement system 102 to better analyze/quantify the differences for training a generative model to generate inpainted pixels.

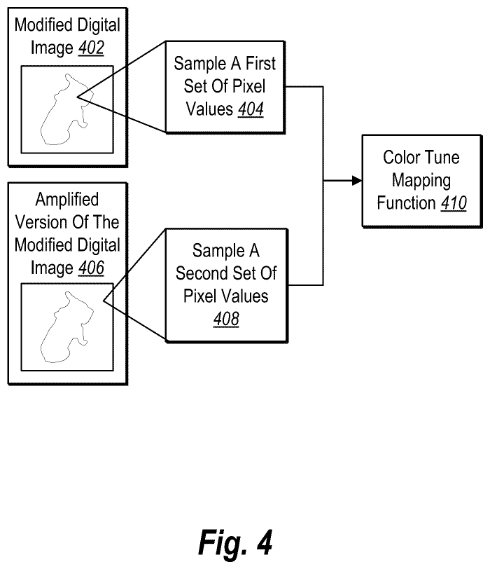

As mentioned above, the color space enhancement system 102 further utilizes the amplified version of the modified digital image to generate a color tune mapping function. FIG. 4 illustrates the color space enhancement system 102 sampling pixel values from both a modified digital image and an amplified version of the modified digital image in accordance with one or more embodiments.

As shown in FIG. 4, the color space enhancement system 102 performs an act 404 of sampling a first set of pixel values from a modified digital image 402 and further performs an act 408 of sampling a second set of pixel values from an amplified version 406 of the modified digital image 402. In one or more embodiments, the color space enhancement system 102 samples sets of pixels from the modified digital image 402 and the amplified version 406 of the modified digital image 402 (e.g., from inside and outside a mask region).

For instance, the color space enhancement system 102 samples a first set of pixel values from the modified digital image 402 and a second set of pixel values from the amplified version 406 of the modified digital image 402, where each set of pixel values includes a sample of pixel values outside a mask region (e.g., outside a hole) and inside a mask region (e.g., inside a hole). Furthermore, the color space enhancement system 102 evenly samples (e.g., selects the same number of pixel values inside the hole and outside the hole) from inside a mask region and from outside a mask region of the modified digital image 402 and the amplified version 406 of the modified digital image 402.

In other words, the color space enhancement system 102 samples a first subset outside of a mask region of the modified digital image 402, a second subset inside a mask region of the modified digital image 402, a third subset outside a mask region of the amplified version 406 of the modified digital image 402, and a fourth subset inside a mask region of the amplified version 406 of the modified digital image 402. Thus, in some embodiments, the first subset and the second subset make up the first set of pixel values and the third subset and the fourth subset make up the second set of pixel values.

Furthermore, as shown in FIG. 4, the color space enhancement system 102 generates a color tune mapping function 410 from the sampled set of pixel values. For instance, the color tune mapping function 410 includes x-values (from inpainted or modified image 402) and γ-values (from the amplified digital image 406) to determine how to map input pixel values to new pixel values. In one or more embodiments, the color space enhancement system 102 uses the x-values from the modified digital image 402 and the y-values obtained from sampling from the amplified version 406 of the modified digital image 402 to generate the color tune mapping function 410. Specifically, the color space enhancement system 102 takes the x-values and the y-values and runs a polynomial regression to generate the color tune mapping function 410.

For instance, a polynomial regression refers to a type of analysis where the relationship between the x-values and the y-values is modeled as a nth-degree polynomial. In other words, a polynomial regression captures non-linear trends, where a higher degree (for a polynomial function) captures more complex curves. To illustrate, the color space enhancement system 102, in one or more embodiments, uses a degree of six for the polynomial regression. Moreover, the color space enhancement system 102 uses the polynomial regression to generate the color tune mapping function 410 by using a fitted polynomial equation (e.g., the captured non-linear trends) to make predictions on new input values (e.g., new pixel values corresponding to modified digital images and ground truth digital images).

As mentioned above, the color space enhancement system 102 uses a color tune mapping function to generate transformed versions of digital images, which enhances subtle and nuanced details depicted within digital images. FIG. 5 illustrates the color space enhancement system 102 generating a transformed version of a modified digital image and a transformed version of a ground truth digital image.

As shown in FIG. 5, the color space enhancement system 102 uses a color tune mapping function 506 (e.g., the color tune mapping function 410 discussed above in FIG. 4) to transform pixel values in a modified digital image 502 (e.g., a digital image with inpainted pixels) and to transform pixel values in a ground truth image 504 (e.g., with unpainted pixels and completed regions). As shown in FIG. 5, the color space enhancement system 102 uses the color tune mapping function 506 to generate a transformed modified digital image 508.

In one or more embodiments, the color space enhancement system 102 generates transformed versions of digital images based on a clamp range 507. Specifically, the clamp range 507 refers to a process of restricting pixel values to a specific range. For example, the color space enhancement system 102 restricts pixel values defined by maximum and minimum allowable values. In particular, the color space enhancement system 102 uses a clamp range of [−1.2, 1.2] to avoid out of range color artifacts in a final digital image (e.g., a transformed digital image).

In one or more embodiments, the transformed modified digital image 508 refers to an image where the color space enhancement system 102 maps pixel values of the modified digital image 502 to new pixel values. Specifically, the transformed modified digital image 508 refers to a digital image that is mapped to different pixel values based on the color tune mapping function 506. For instance, the color space enhancement system 102 uses the transformed modified digital image 508 to better capture perceptual differences (e.g., nuance and subtle differences) in a digital image to teach a generative model to better generate digital images without inpainting artifacts or to reduce inpainting artifacts (e.g., relative to existing generative systems).

Furthermore, as also shown in FIG. 5, the color space enhancement system 102 uses the color tune mapping function 506 to generate a transformed ground truth image 510 of the ground truth image 504. In one or more embodiments, the transformed ground truth image 510 of the ground truth image 504 refers to the color space enhancement system 102 mapping pixel values of the ground truth image 504 to new pixel values. Specifically, the transformed ground truth image 510 refers to a digital image that is mapped to different pixel based on the color tune mapping function 506.

Similar to the transformed modified digital image 508, the color space enhancement system 102 uses the transformed ground truth image 510 of the ground truth image 504 to more accurately determine a measure of loss between the modified digital image 502 and the ground truth image 504. In essence, the color space enhancement system 102 amplifies or highlights more subtle perceptual differences between the modified digital image 502 and the ground truth image 504 by generating the transformed modified digital image 508 and the transformed ground truth image 510.

As is discussed in FIGS. 3-5, the color space enhancement system 102 generates a color tune mapping function to transform digital images to different pixel values. In one or more embodiments, the color space enhancement system 102 the following algorithm outlines the process shown in FIGS. 3-5:

Step 1: perform a color difference enhancement: amplified version of modified digital image =
ground truth image + beta * (modified digital image − ground truth image).
Step 2: evenly sample pixel values from the modified digital image and the amplified version
of the modified digital image, such that pixels are sampled from inside and outside the hole
(e.g., a masked region), to make the data point balanced.
Step 3: take sampled pixel values from the modified digital image as x and take the sampled
pixel values from the amplified version of the modified digital image as y, run a polynomial
regression (degree = 6, differentiable) to generate the color tune mapping function.
Step 4: run this color tune mapping function on the modified digital image and the ground
truth image, to generate a transformed modified digital image and a transformed ground truth
image.

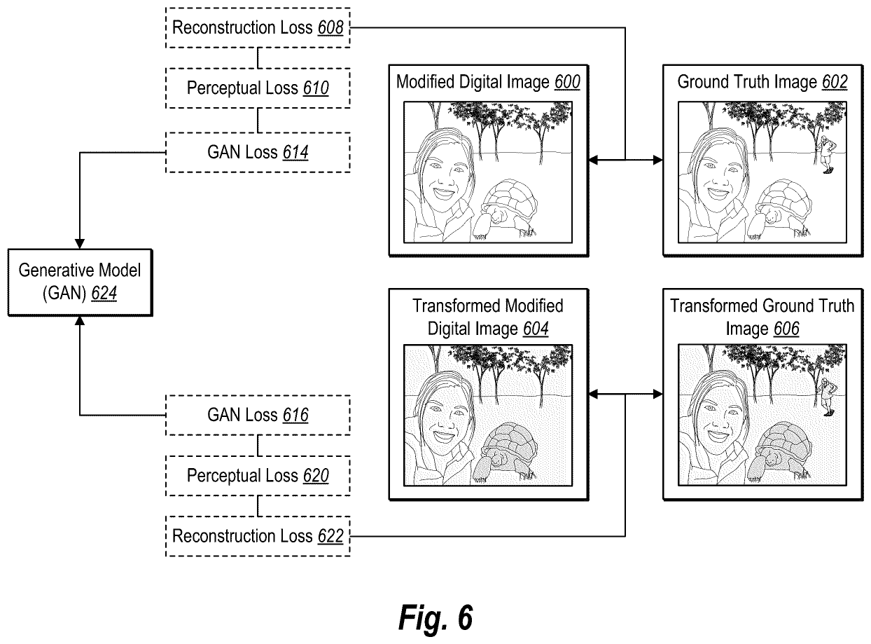

As mentioned above, the color space enhancement system 102 utilizes various measures of loss to modify parameters of a generative model. FIG. 6 illustrates the color space enhancement system 102 generating multiple measures of loss from comparing a modified digital image with a ground truth image and a transformed modified digital image with a transformed ground truth image. For example, FIG. 6 shows the color space enhancement system 102 comparing a modified digital image 600 with a ground truth image 602 and comparing a transformed modified digital image 604 with a transformed ground truth image 606 to generate multiple measures of loss. Specifically, FIG. 6 shows the color space enhancement system 102 generating reconstruction loss 608, perceptual loss 610, and GAN loss 614 for the comparison between the modified digital image 600 and the ground truth image 602. Further, FIG. 6 shows the color space enhancement system 102 generating reconstruction loss 622, perceptual loss 620, and GAN loss 616 for the comparison between the transformed modified digital image 604 and the transformed ground truth image 606.

In one or more embodiments, reconstruction loss refers to a measure of the degree of closeness for a decoder output to the original output. Specifically, in some embodiments, the color space enhancement system 102 utilizes a mean-squared error or a L1 loss to determine the reconstruction loss. In other words, the reconstruction loss measures a fidelity between the original/ground truth (initial) digital image and a newly generated digital image. Furthermore, a partial reconstruction loss measures the fidelity between only the reconstructed part in the generated image that exists within the original digital image (ground truth image). In one or more embodiments, L1 loss refers to mean absolute error loss used for image-based tasks. Specifically, L1 loss measures the absolute differences between the predicted values and the ground truth values. In contrast with L2 loss (e.g., mean squared error), L1 loss is less sensitive to outliers and use useful for image reconstruction tasks.

In one or more embodiments, perceptual loss refers to a comparison of high-level features between a generated image (e.g., modified digital image) and a ground truth reference. Specifically, a perceptual loss involves comparing activations or feature maps of various layers of the neural network-based refiner model against feature maps of ground truth references (e.g., rather than comparing pixel values directly). For instance, a perceptual loss aims to capture perceptually meaningful differences between images, rather than being limited to pixel-wise differences.

As mentioned previously, a discriminator and a GAN attempt to generate a realistic-looking digital image. For example, the color space enhancement system 102 determines adversarial loss for a generative model (e.g., the neural network-based refiner model). In particular, the adversarial loss (e.g., GAN loss) includes the GAN and discriminator attempting to trick one another in a zero-sum game. Specifically, the GAN attempts to train the generator to produce realistic data, while the discriminator tries to distinguish between real data and fake data.

Furthermore, the GAN loss involves a measure of loss for the generator and a measure of loss for the discriminator. For instance, the color space enhancement system 102 utilizes a binary cross-entropy loss to classify whether a given input is real or fake (e.g., the discriminator is encouraged to correctly classify fake data as fake) and the generator loss is designed to encourage the generator to generate data that maximizes the probability of being classified as real by the discriminator. Moreover, the color space enhancement system 102 uses a total GAN loss, which is a sum of the generator loss and the discriminator loss.

As shown in FIG. 6, the color space enhancement system 102 generates various measures of loss and utilizes the measures of loss to modify parameters of a generative model 624. Specifically, the color space enhancement system 102 utilizes the various measures of loss generated from the transformed modified digital image 604 and the transformed ground truth image 606 (which make up the adaptive color tune transformation loss) to increase the accuracy of the generative model 624 in generating inpainted pixels that do not contain/reduce inpainting artifacts.

As mentioned above, the color space enhancement system 102 trains a generative model utilizing the color space transformation to enhance to accuracy of generating realistic, detailed, and nuanced inpainted pixels in a digital image. In particular, the color space enhancement system 102 reduces/avoids inpainting artifact issues faced by existing systems by amplifying/enhancing subtle details between ground truth images and inpainted images during training time, which improves the manner in which generative models create inpainted pixels.

As mentioned above, the color space enhancement system 102 optimizes parameters of a generative model to eliminate/reduce inpainting artifacts. As also mentioned above, inpainting artifacts include boundary cut-offs, color shifting, texture mismatches, and noise pattern mismatches. In one or more embodiments, a boundary cut-off refers to visual distortions in a digital image that occur near a boundary or edge of an image or processed regions of an image. Specifically, boundary cut-off includes a loss of detail near or at the boundary of processed regions in an image. For instance, the boundary cut-off includes blurry portions of a digital image, pixelated portions, or otherwise distorted regions. To illustrate, as mentioned above, the modified digital images include artifacts such as boundary cut-off which takes the form of sharp or unnatural edges, blurry or missing content, or discontinuities portrayed within the digital image.

In one or more embodiments, color shifting refers to a perceptible change or alteration in colors of a digital image that deviates from an expected or initial color representation of the digital image. Specifically, the color shifting includes noticeable changes in hue, saturation, or brightness that is inconsistent with the rest of the digital image. To illustrate, a hue shift includes an overall alteration in the hue of the image (e.g., reds become more orange, or blues become greener), a saturation shift (e.g., colors appear more or less vibrant than intended), and a brightness or lightness shift (e.g., the overall lightness or darkness of colors may change which leads to an image that appears lighter or darker than expected).

In one or more embodiments, texture mismatches refer to visible distortions or inconsistencies in the digital image regarding an appearance of texture. Specifically, the patterns, details or surface qualities depicted in a digital image appear distorted or inconsistent with one another. As such, texture mismatches typically result in unnatural transitions or visible seams within the digital image.

In one or more embodiments, noise pattern mismatches refer to a visible distortion or inconsistency in a digital image caused by noise pattern discrepancies. Specifically, noise pattern mismatches refer to grain, random pixel variations, or distorted patterns in a digital image that result in a non-uniform-distribution across the digital image. For instance, the digital image contains different types of noise or compression artifacts that vary across the image and give the image a distorted appearance.

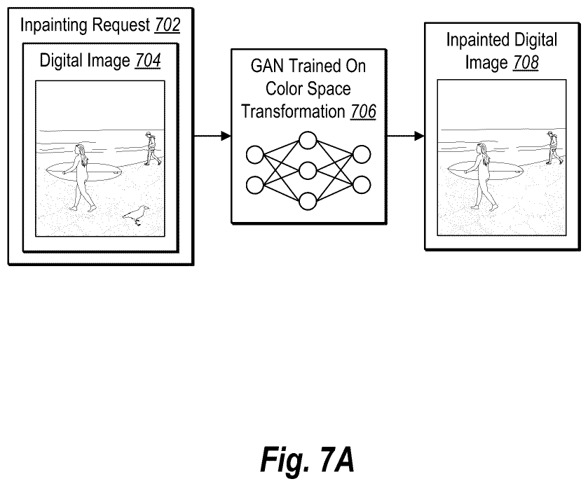

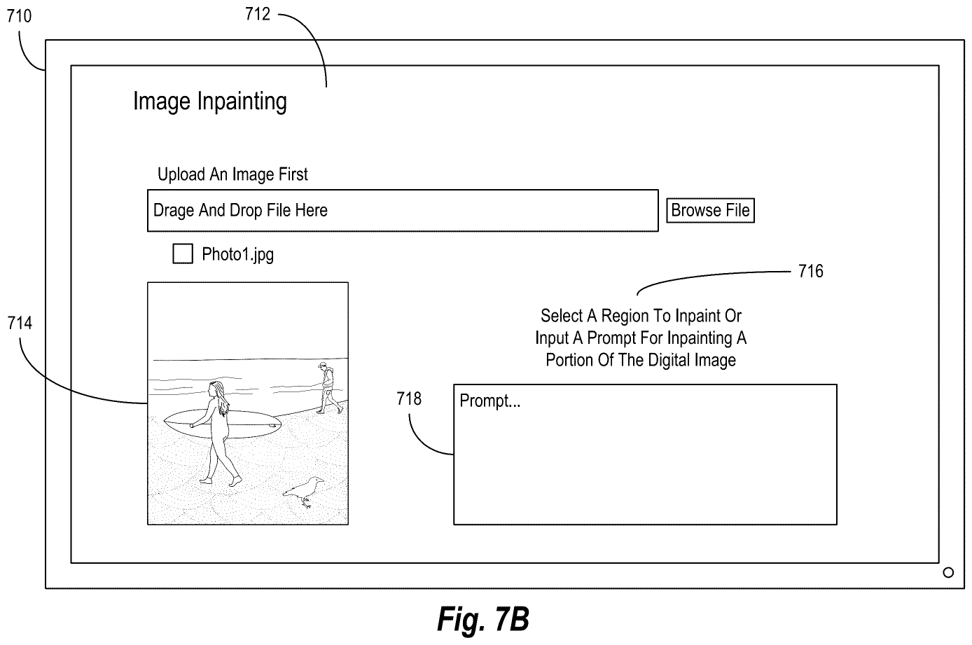

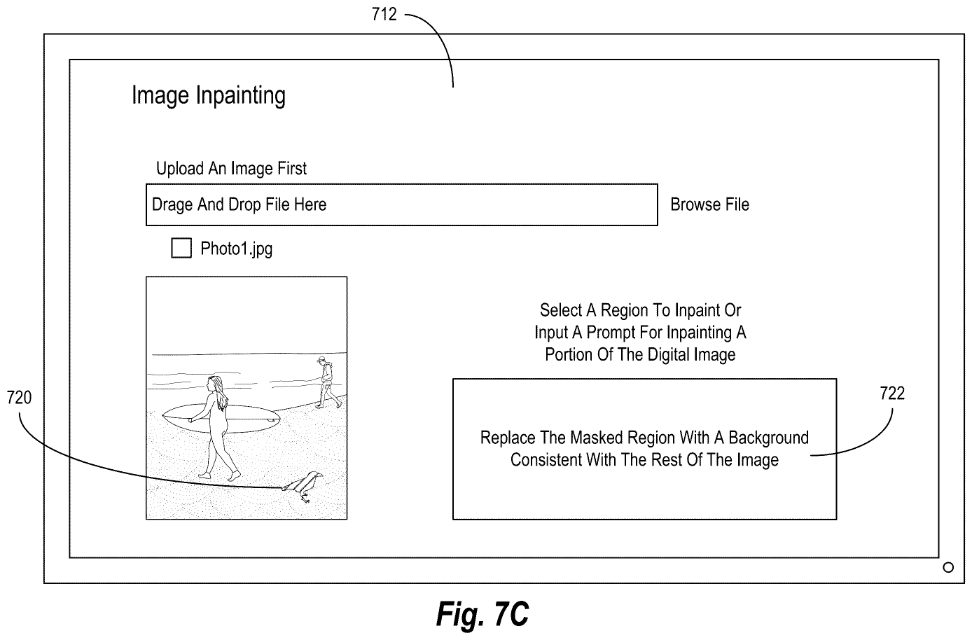

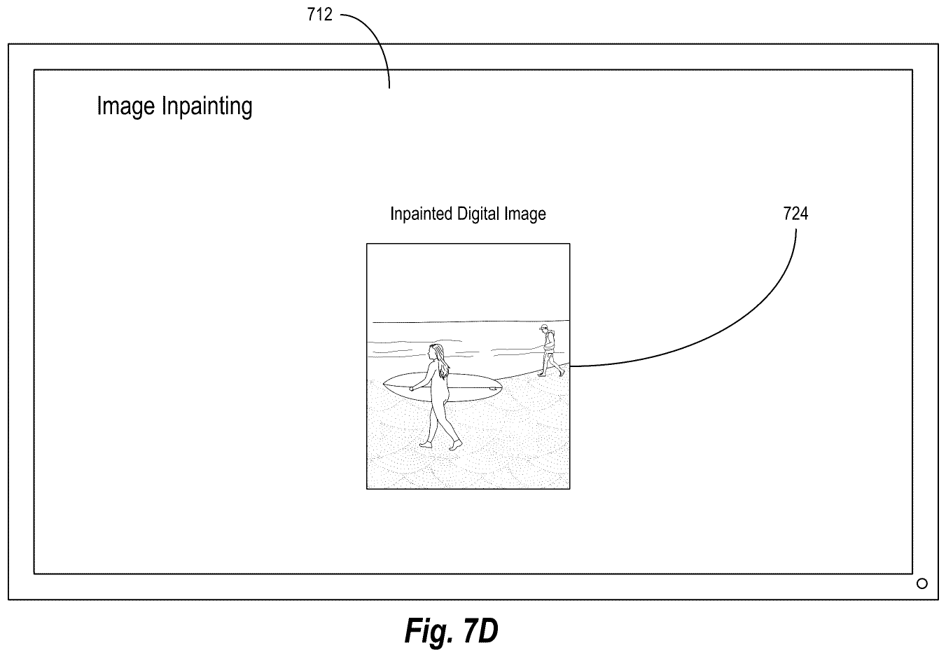

FIGS. 7A-7D illustrate the color space enhancement system 102 and graphical user interfaces provided thereby at inference time generating an inpainted digital image in accordance with one or more embodiments. As shown in FIG. 7A, the color space enhancement system 102 receives an inpainting request 702 that contains a digital image 704. In one or more embodiments, the color space enhancement system 102 receives the inpainting request 702 from a client device.

For example, the color space enhancement system 102 receives the inpainting request 702 that includes the digital image 704 and further includes a prompt to modify one or more aspects of the digital image. Specifically, the color space enhancement system 102 determines infill modifications for the digital image 704 based on the inpainting request (e.g., prompt). For instance, the infill modification includes infilling an indicated region or outpainting an expansion of the digital image. For example, the inpainting request includes a request to add pixel values and/or replace pixel values with new pixel values. Accordingly, the inpainting request includes a request to add pixel values to a digital image to either fill a gap or to replace a region/object depicted within the digital image 704 or to expand the digital image 704.

As shown, the color space enhancement system 102 receives the inpainting request 702 and utilizes a GAN 706 trained on a color space transformation (e.g., discussed above) to generate an inpainted digital image 708. Specifically, the color space enhancement system 102 utilizes the generator of the GAN 706 at inference time to generate the inpainted digital image 708. For instance, the color space enhancement system 102 utilizes the generator of the GAN 706 to process the inpainting request 702 (e.g., which contains the digital image 704) and produces additional data (e.g., the inpainted digital image 708) from the inpainting request 702. To illustrate, the generator portion of the GAN at inference time contains various down-sampling layers such as an input layer. For instance, the input layer processes a latent vector along with conditioning information (e.g., the inpainting request 702, the digital image 704, mask channel, digital image with a region masked) and transforms the latent vector into a higher-dimensional feature map.

In other words, the color space enhancement system 102 utilizes the generator portion of the GAN as a hierarchical encoder. As mentioned, each layer of the plurality of layers corresponds with a different image resolution. In particular, down-sampling includes moving from the full digital image resolution (e.g., 256×512) and moving one resolution lower. Furthermore, the color space enhancement system 102 for down-sampling also utilizes skip connections to corresponding layers.

In one or more embodiments, the generator portion of the GAN does not contain up-sampling layers (e.g., up-sampling includes moving from a lower resolution for a digital image to a higher resolution) but includes down-sampling layers to generate inpainted pixels with reduced or no inpainting artifacts. Specifically, the color space enhancement system 102 receives the digital image 704 at a specific image resolution and uses the GAN 706 trained on the color space transformation to generate the inpainted digital image 708 at the same image resolution. In other words, the color space enhancement system 102 utilizes the GAN 706 to adjust the texture and color inside a masked region of the digital image 704 to match the surrounding color and texture in the digital image 704.

FIG. 7B illustrates a graphical user interface 712 provided on a client device 710. Specifically, the graphical user interface 712 shows an option to upload an image and further shows an upload of a digital image 714. Moreover, the graphical user interface 712 shows an option for to submit a prompt 718 and/or to further perform an act 716 of selecting a region to inpaint in the digital image 714. For instance, the color space enhancement system 102 receives a digital sketch or input from the client device 710 (e.g., via a drawing tool) that indicates a portion of the digital image 714 to inpaint.

In one or more embodiments, the color space enhancement system 102 receives a sketch from a client device laid over the digital image 714. Specifically, the color space enhancement system 102 receives input from the client device that traces over a specific region (e.g., object, such as a car) in the digital image 714. From the input (e.g., the digital sketch) from the client device, the color space enhancement system 102 further generates the digital image 714 with a mask corresponding to the portion indicated by the digital sketch.

FIG. 7C illustrates an input 722 (e.g., user input as the prompt) entered into the graphical user interface 712 that includes a digital sketch/outline around the bird portrayed in the digital image 714. Moreover, FIG. 7C shows the color space enhancement system 102 receiving a prompt from the client device 710. In particular, the color space enhancement system 102 receives the prompt 718 of “replace the bird with a background consistent with the rest of the image.” Although FIG. 7C shows both a mask 720 (e.g., a mask covering the bird depicted in the digital image 714) in the digital image 714 and the prompt 718 describing the inpainting task, in one or more embodiments, the color space enhancement system 102 receives either the mask 720 or the prompt 718.

Furthermore, in some embodiments, if the inpainting task is described in just the prompt 718, the color space enhancement system 102 utilizes a segmentation model to segment a portion of the digital image. In particular, the color space enhancement system 102 utilizes a segmentation neural network to assign a label to various pixels within the digital image 714. Specifically, the color space enhancement system 102 assigns labels to every pixel within the digital image or just identifies pixels with a bird label. For instance, the color space enhancement system 102 assigns a label to pixels in a manner that groups pixels together that share certain characteristics (e.g., background portion, a foreground portion, or any portion of the digital image indicated by a client device). As an example, the color space enhancement system 102 segments the digital image 714 to assist generative models in locating objects and boundaries within the digital image.

As mentioned above, the color space enhancement system 102 utilizes neural networks. For example, the color space enhancement system 102 utilizes a segmentation neural network. In particular, the segmentation neural network receives an input digital image and further receives a specific indication within the digital image 714 (e.g., as indicated by a sketch/input from a client device 710) and generates encodings for each pixel value within the digital image 714 and/or the sketch/input from the client device 710. Based on the encodings, the segmentation neural network generates a segmented digital image (e.g., the digital image with a mask).

FIG. 7D illustrates the color space enhancement system 102 providing a generated inpainted digital image 724 via the graphical user interface 712. Specifically, the color space enhancement system 102 utilizes a GAN trained on the color space transformation to generate the inpainted digital image 724 that reduces/avoids generating inpainted pixels with inpainting artifacts.

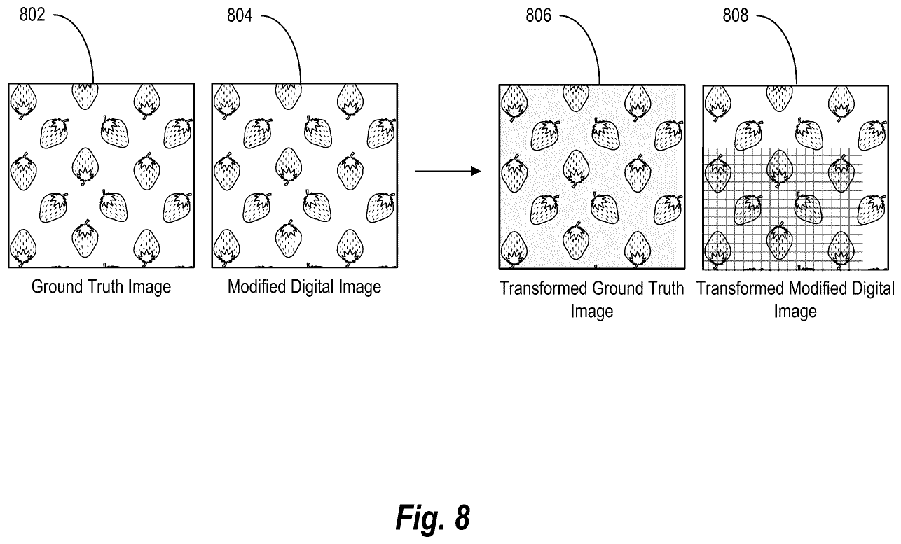

FIG. 8 further illustrates results of the color space enhancement system 102. As mentioned above, the color space enhancement system 102 transforms/enhances pixel differences in a ground truth image and a modified digital image as part of an adaptive color tune transformation loss to better inform a generative model in eliminating/reducing inpainting artifacts (e.g., relative to existing systems). For example, FIG. 8 shows a ground truth image 802 and a modified digital image 804 (e.g., modified to include inpainted pixels) and further shows that a transformed ground truth image 806 depicts accentuated/highlighted pixel values relative to the ground truth image 802.

Likewise, the transformed modified digital image 808 also contains accentuated/highlighted pixel values relative to the modified digital image 804. In particular, the color space enhancement system 102 takes the accentuated/highlighted pixel values depicted in the transformed ground truth image 806 and the transformed modified digital image 808 and compares the two to determine the pixel differences at a more detailed level (e.g., relative to just comparing the ground truth image 802 and the modified digital image 804). In doing so, the color space enhancement system 102 better accounts for important but subtle details that help the generative model create realistic and natural inpainted pixels (e.g., while eliminating and/or reducing inpainting artifacts).

In one or more embodiments, experimenters evaluated loss measures generated from transformed images compared to loss measures not generated by transformed images. For example, in some instances, the experimenters determined that the loss magnitude (e.g., for L1 loss) is amplified by 30% for the ground truth image 802 relative to the transformed ground truth image 806 and for the modified digital image 804 relative to the transformed modified digital image 808.

As mentioned above, the color space enhancement system 102 further utilizes a clamp range, a preset value (e.g., beta), and a degree for the polynomial regression. In one or more embodiments, the color space enhancement system 102 utilizes the clamp range, the preset value (e.g., a range of preset values), and the degree for the polynomial regression to stabilize training of a generative model in performing generative inpainting tasks. Accordingly, as briefly mentioned above, the color space enhancement system 102 establishes a degree of six for the polynomial regression and utilizes a clamp range between −1.2 to 1.2 to avoid very large values out of range which results in more stable training of the generative model.

Turning to FIG. 9, additional detail will now be provided regarding various components and capabilities of the color space enhancement system 102. In particular, FIG. 9 illustrates an example schematic diagram of a computing device 900 (e.g., the server device(s) 104 and/or the client device 110) implementing the color space enhancement system 102 in accordance with one or more embodiments of the present disclosure for components 900-910. As illustrated in FIG. 9, the color space enhancement system 102 includes a modified digital image manager 902, a generative model 903, a loss manager 904, a transformed image manager 906, a color space transformation 907, a parameter modification manager 908, and a storage manager 910.

The modified digital image manager 902 generates a modified digital image from a digital image. For example, the modified digital image manager 902 receives a digital image with an indicated region within the digital image. Specifically, the modified digital image manager 902 receives the digital image and a masked region within the digital image, for which the modified digital image manager 902 inpaints within the masked region. For instance, the modified digital image manager 902 employs the generative model 903 to generate inpainted pixels to conform with the remainder of the digital image. Furthermore, in some embodiments, the modified digital image manager 902 accounts for text prompt instructions included as part of a inpainting request to generate the modified digital image. Moreover, the modified digital image manager 902 works hand in hand with the generative model 903 to perform one or more generative tasks. In some instances, the generative model is a generative adversarial neural network.

The loss manager 904 generates one or more measures of loss based on comparing a digital image with a ground truth reference. Specifically, the loss manager 904 compares a modified digital image (e.g., with inpainted pixels) with a ground truth reference and generates a measure of loss. Furthermore, the loss manager 904 also compares transformed versions of digital images (e.g., transformed according to a color space transformation) and generates an additional measure of loss (e.g., an adaptive color tune transformation loss).

The transformed image manager 906 generates a transformed modified digital image and a transformed ground truth image. Specifically, the transformed image manager 906 transforms pixel values of the modified digital image and further transforms pixel values of the ground truth version of the digital image by leveraging the color space transformation 907. In doing so, the transformed image manager 906 generates enhanced digital images that highlights the differences between the modified digital image and the ground truth version of the digital image. Thus, the transformed image manager 906 works in tandem with the color space transformation 907 to create an amplified version of the modified digital image and further create the transformed images from the amplified version.

The parameter modification manager 908 works with the loss manager 904 to obtain the various measures of loss obtained from comparing digital images with ground truth references. Specifically, the parameter modification manager 908 modifies parameters of a generative model based on the obtained measures of loss from the loss manager 904. For instance, the parameter modification manager 908 fine-tunes/updates the weights and parameters of the generative model (e.g., a GAN) to reflect the enhanced differences between a modified digital image and a ground truth image such that the GAN is tailored to eliminate/reduce inpainting artifacts.

The storage manager 910 stores various components discussed in FIG. 9. For example, the storage manager 910 stores the generative model 903, the color space transformation 907, digital images, modified digital images, measures of loss, and transformed digital images. Additionally, the storage manager 910 also stores training components such as a training dataset (e.g., image data pairs with augmented images and ground truth images) and the generated image pairs used to train a generative model.

Each of the components 900-910 of the color space enhancement system 102 include software, hardware, or both. For example, the components 900-910 include one or more instructions stored on a computer-readable storage medium and executable by processors of one or more computing devices, such as a client device or server device. When executed by the one or more processors, the computer-executable instructions of the color space enhancement system 102 cause the computing device(s) to perform the methods described herein. Alternatively, the components 900-910 include hardware, such as a special-purpose processing device to perform a certain function or group of functions. Alternatively, the components 900-910 of the color space enhancement system 102 include a combination of computer-executable instructions and hardware.

Furthermore, the components 900-910 of the color space enhancement system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 900-910 of the color space enhancement system 102 may be implemented as a stand-alone application, such as a desktop or mobile application. Furthermore, the components 900-910 of the color space enhancement system 102 may be implemented as one or more web-based applications hosted on a remote server. Alternatively, or additionally, the components 900-910 of the color space enhancement system 102 may be implemented in a suite of mobile device applications or “apps.” For example, in one or more embodiments, the color space enhancement system 102 comprise or operate in connection with digital software applications such as ADOBE® PHOTOSHOP, ADOBE® LIGHTROOM, ADOBE® PHOTOSHOP CC, ADOBE® PHOTOSHOP CAMERA, ADOBE® PHOTOSHOP MOBILE, ADOBE® PHOTOSHOP ELEMENTS, ADOBE® PHOTOSHOP EXPRESS, and ADOBE® FIREFLY.

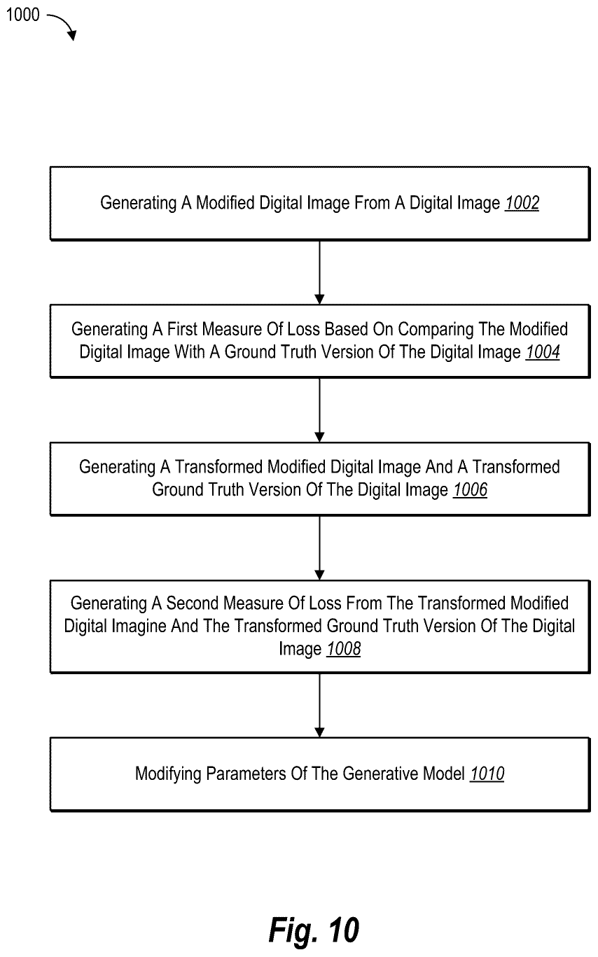

FIGS. 1-9, the corresponding text, and the examples provide a number of different methods, systems, devices, and non-transitory computer-readable media of the components 902-910. In addition to the foregoing, one or more embodiments are described in terms of flowcharts comprising acts for accomplishing the particular result. For example, FIG. 10 illustrates a flowchart of example sequences of acts in accordance with one or more embodiments.

FIG. 10 illustrates a flowchart of a series of acts 1000 for modifying parameters of a generative model using a color space transformation in accordance with one or more embodiments. FIG. 10 illustrates acts according to one embodiment, alternative embodiments may omit, add to, reorder, and/or modify any of the acts shown in FIG. 10. In some implementations, the acts of FIG. 10 are performed as part of a method. For example, in some embodiments, the acts of FIG. 10 are performed as part of a computer-implemented method. Alternatively, a non-transitory computer-readable medium stores instructions thereon that, when executed by at least one processor, cause a computing device to perform the acts of FIG. 10. In some embodiments, a system performs the acts of FIG. 10. For example, in one or more embodiments, a system includes at least one memory device. The system further includes at least one server device configured to cause the system to perform the acts of FIG. 10.

The series of acts 1000 includes an act 1002 of generating a modified digital image from a digital image. Further, the series of acts 1000 includes an act 1004 of generating a first measure of loss based on comparing the modified digital image with a ground truth version of the digital image. Moreover, the series of acts 1000 includes an act 1006 of generating a transformed modified digital image and a transformed ground truth version of the digital image. Further, the series of acts 100 includes an act 1008 of generating a second measure of loss from the transformed modified digital image and the transformed ground truth version of the digital image. Moreover, the series of acts 1000 includes an act 1010 of modifying parameters of the generative model.

In particular, the act 1002 includes generating, utilizing a generative model, a modified digital image from a digital image by inpainting a region of the digital image. Further, the act 1004 includes generating a first measure of loss based on comparing the modified digital image with a ground truth version of the digital image with the region complete. Moreover, the act 1006 includes generating a transformed modified digital image and a transformed ground truth image of the digital image by performing a color space transformation on the modified digital image and on the ground truth version of the digital image. Further, the act 1008 includes generating a second measure of loss based on comparing the transformed modified digital image with the transformed ground truth image of the digital image. Moreover, the act 1010 includes modifying parameters of the generative model based on the first measure of loss and the second measure of loss.

For example, in one or more embodiments, the series of acts 1000 includes generating an amplified version of the modified digital image by applying a color difference enhancement to the modified digital image. In addition, in one or more embodiments, the series of acts 1000 includes determining a difference in pixel values of the modified digital image and the ground truth version of the digital image. Further, in one or more embodiments, the series of acts 1000 includes enhancing the difference in pixel values of the modified digital image and the ground truth version of the digital image by a preset value. Further, in some embodiments, the series of acts 1000 includes combining the enhanced difference in color values with the ground truth version to generate the amplified version of the modified digital image, wherein the amplified version of the modified digital image indicates a color difference between the modified digital image and the ground truth version of the digital image.

Moreover, in one or more embodiments, the series of acts 1000 includes sampling a first set of pixel values from the modified digital image. Further, in one or more embodiments, the series of acts 1000 includes sampling a second set of pixel values from an amplified version of the modified digital image. Moreover, in one or more embodiments, the series of acts 1000 includes generating the modified digital image comprises generating inpainted pixels for a region within the digital image indicated by a mask. Further, in one or more embodiments, the series of acts 1000 includes sampling the first set of pixel values and the second set of pixel values comprises evenly sampling from pixel values inside the region indicated by the mask and outside the region indicated by the mask.

Moreover, in one or more embodiments, the series of acts 1000 includes utilizing the first set of pixel values from the modified digital image as x-values. Additionally, in one or more embodiments, the series of acts 1000 includes utilizing the second set of pixel values from the amplified version of the modified digital image as y-values. In one or more embodiments, the series of acts 1000 includes generating, from the x-values and the y-values, a color tune mapping function of a color difference between the modified digital image and the ground truth version of the digital image.

Moreover, in one or more embodiments, series of acts 1000 includes applying the color tune mapping function to the modified digital image to generate the transformed modified digital image by transforming pixel values in the modified digital image to match the color tune mapping function. For example, in one or more embodiments, the series of acts 1000 includes applying the color tune mapping function to the ground truth version of the digital image to generate the transformed ground truth image by transforming pixel values in the ground truth version to match the color tune mapping function.

In addition, in one or more embodiments, the series of acts 1000 includes generating, utilizing a generative model, a modified digital image from a digital image by inpainting a region of the digital image. Further, in one or more embodiments, the series of acts 1000 includes generating an amplified version of the modified digital image that indicates a color difference between the modified digital image and a ground truth version of the digital image. Further, in some embodiments, the series of acts 1000 includes sampling a set of pixels from the modified digital image and the amplified version of the modified digital image. Moreover, in some embodiments, the series of acts 1000 includes generating a color tune mapping function based on the set of pixels from the modified digital image and the amplified version of the modified digital image. In one or more embodiments, the series of acts 1000 includes generating, utilizing the color tune mapping function, a transformed modified digital image and a transformed version of the ground truth version of the digital image.

Furthermore, in one or more embodiments, the series of acts 1000 includes determining a difference in pixel values of the modified digital image and the ground truth version of the digital image. Moreover, in one or more embodiments, the series of acts 1000 includes enhancing the difference in pixel values of the modified digital image and the ground truth version of the digital image by a preset value. Moreover, in one or more embodiments, the series of acts 1000 includes combining the enhanced difference in color values with the ground truth version to generate the amplified version of the modified digital image. Further, in one or more embodiments, the series of acts 1000 includes sampling a first subset of pixels from the modified digital image in a masked region indicated in the digital image. In one or more embodiments, the series of acts 1000 includes sampling a second subset of pixels from the modified digital image outside of the masked region indicated in the digital image.

Moreover, in one or more embodiments, the series of acts 1000 includes sampling a third subset of pixels from the amplified version of the modified digital image in a masked region indicated in the digital image. Further, in one or more embodiments, the series of acts 1000 includes sampling a fourth subset of pixels from the amplified version of the modified digital image outside of the masked region indicated in the digital image.

Moreover, in some embodiments, the series of acts 1000 includes utilizing a first subset of pixels and a second subset of pixels as x-values. Further, in some embodiments, the series of acts 1000 includes utilizing the third subset of pixels and the fourth subset of pixels as y-values. Moreover, in some embodiments, the series of acts 1000 includes generating the color tune mapping function from the x-values and the y-values that indicates a color difference between the modified digital image and the ground truth version of the digital image.

Furthermore, in one or more embodiments, the series of acts 1000 includes determining a clamp range for the transformed modified digital image. Moreover, in one or more embodiments, the series of acts 1000 includes based on the clamp range, generating the transformed modified digital image by applying the color tune mapping function to the modified digital image to transform pixel values in the modified digital image to match the color tune mapping function. Further, in one or more embodiments, the series of acts 1000 includes based on the clamp range, generating the transformed version of the ground truth version of the digital image by applying the color tune mapping function to the ground truth version of the digital image to transform pixel values in the ground truth version to match the color tune mapping function. For example, in one or more embodiments, the series of acts 1000 includes modifying parameters of the generative model based on comparing the transformed modified digital image with the transformed version of the ground truth version of the digital image, wherein the generative model comprises a generative adversarial neural network.

In addition, in one or more embodiments, the series of acts 1000 includes receiving a request to inpaint a digital image. Further, in one or more embodiments, the series of acts 1000 includes generating, utilizing a generative model trained utilizing color space transformation to avoid generating inpainting artifacts, an inpainted digital image from the digital image by inpainting a region of the digital image. Further, in some embodiments, the series of acts 1000 includes providing the inpainted digital image for display via a graphical user interface.

Furthermore, in one or more embodiments, the series of acts 1000 includes receiving a digital sketch over a region of the digital image. Moreover, in one or more embodiments, the series of acts 1000 includes generating, utilizing a segmentation model, a mask for the region of the digital image from the digital sketch. Further, in one or more embodiments, the series of acts 1000 includes receiving an indication to inpaint the region in the digital image, wherein the region is indicated by a mask. Further, in some embodiments, the series of acts 1000 includes generating inpainted pixels to replace the region indicated by the mask in the digital image in a manner that reduces inpainting artifacts along a border of the region. Furthermore, in one or more embodiments, the series of acts 1000 includes training the generative model utilizing the color space transformation by generating an amplified version of a training digital image by determining a difference in pixel values of the training digital image and a ground truth version of the training digital image and enhancing the difference in pixel values by an enhancement factor.

Furthermore, in one or more embodiments, the series of acts 1000 includes generating a color tune mapping function based on sampling pixel values from the training digital image and the amplified version of the training digital image. Moreover, in one or more embodiments, the series of acts 1000 includes generating a transformed training digital image and a transformed ground truth image of the training digital image by using the color tune mapping function. In one or more embodiments, the series of acts 1000 includes modifying parameters of the generative model based on comparing the training digital image with the ground truth version of the training digital image and comparing the transformed training digital image and the transformed ground truth image of the training digital image.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., the server device(s) 104 and/or the client device 110). In one or more embodiments, the computing device 1100 may be a mobile device (e.g., a mobile telephone, a smartphone, a PDA, a tablet, a laptop, a camera, a tracker, a watch, a wearable device). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 include hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 including storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A non-transitory computer-readable medium comprising instructions that, when executed by at least one processor, cause the at least one processor to perform operations comprising:
generating, utilizing a generative model, a modified digital image from a digital image by inpainting a region of the digital image;
generating a first measure of loss based on comparing the modified digital image with a ground truth version of the digital image with the region complete;
generating a transformed modified digital image and a transformed ground truth image of the digital image by performing a color space transformation on the modified digital image and on the ground truth version of the digital image;
generating a second measure of loss based on comparing the transformed modified digital image with the transformed ground truth image of the digital image; and
modifying parameters of the generative model based on the first measure of loss and the second measure of loss.

2. The non-transitory computer-readable medium of claim 1, wherein generating the transformed modified digital image and the transformed ground truth image of the digital image comprises generating an amplified version of the modified digital image by applying a color difference enhancement to the modified digital image.

3. The non-transitory computer-readable medium of claim 2, wherein applying the color difference enhancement to the modified digital image comprises:
determining a difference in pixel values of the modified digital image and the ground truth version of the digital image; and
enhancing the difference in pixel values of the modified digital image and the ground truth version of the digital image by a preset value.

4. The non-transitory computer-readable medium of claim 3, further comprising combining the enhanced difference in color values with the ground truth version to generate the amplified version of the modified digital image, wherein the amplified version of the modified digital image indicates a color difference between the modified digital image and the ground truth version of the digital image.

5. The non-transitory computer-readable medium of claim 1, further comprising:
sampling a first set of pixel values from the modified digital image; and
sampling a second set of pixel values from an amplified version of the modified digital image.

6. The non-transitory computer-readable medium of claim 5, wherein:
generating the modified digital image comprises generating inpainted pixels for a region within the digital image indicated by a mask; and
sampling the first set of pixel values and the second set of pixel values comprises evenly sampling from pixel values inside the region indicated by the mask and outside the region indicated by the mask.

7. The non-transitory computer-readable medium of claim 5, further comprising:
utilizing the first set of pixel values from the modified digital image as x-values;
utilizing the second set of pixel values from the amplified version of the modified digital image as y-values; and
generating, from the x-values and the y-values, a color tune mapping function of a color difference between the modified digital image and the ground truth version of the digital image.

8. The non-transitory computer-readable medium of claim 7, wherein generating the transformed modified digital image and the transformed ground truth image of the digital image comprises:
applying the color tune mapping function to the modified digital image to generate the transformed modified digital image by transforming pixel values in the modified digital image to match the color tune mapping function; and
applying the color tune mapping function to the ground truth version of the digital image to generate the transformed ground truth image by transforming pixel values in the ground truth version to match the color tune mapping function.

9. A system comprising:
one or more memory devices; and
one or more processors coupled to the one or more memory devices that cause the system to perform operations comprising:
generating, utilizing a generative model, a modified digital image from a digital image by inpainting a region of the digital image;
generating an amplified version of the modified digital image that indicates a color difference between the modified digital image and a ground truth version of the digital image;
sampling a set of pixels from the modified digital image and the amplified version of the modified digital image;
generating a color tune mapping function based on the set of pixels from the modified digital image and the amplified version of the modified digital image; and
generating, utilizing the color tune mapping function, a transformed modified digital image and a transformed version of the ground truth version of the digital image.

10. The system of claim 9, wherein generating the amplified version of the modified digital image comprises:
determining a difference in pixel values of the modified digital image and the ground truth version of the digital image;
enhancing the difference in pixel values of the modified digital image and the ground truth version of the digital image by a preset value; and
combining the enhanced difference in color values with the ground truth version to generate the amplified version of the modified digital image.

11. The system of claim 9, wherein sampling the set of pixels from the modified digital image comprises:
sampling a first subset of pixels from the modified digital image in a masked region indicated in the digital image; and
sampling a second subset of pixels from the modified digital image outside of the masked region indicated in the digital image.

12. The system of claim 9, wherein sampling the set of pixels from the amplified version of the modified digital image comprises:
sampling a third subset of pixels from the amplified version of the modified digital image in a masked region indicated in the digital image; and
sampling a fourth subset of pixels from the amplified version of the modified digital image outside of the masked region indicated in the digital image.

13. The system of claim 12, wherein the operations further comprise:
utilizing a first subset of pixels and a second subset of pixels as x-values; and
utilizing the third subset of pixels and the fourth subset of pixels as y-values.

14. The system of claim 13, wherein generating the color tune mapping function comprises generating the color tune mapping function from the x-values and the y-values that indicates a color difference between the modified digital image and the ground truth version of the digital image.

15. The system of claim 14, wherein generating the transformed modified digital image and the transformed version of the ground truth version of the digital image comprises:
determining a clamp range for the transformed modified digital image;
based on the clamp range, generating the transformed modified digital image by applying the color tune mapping function to the modified digital image to transform pixel values in the modified digital image to match the color tune mapping function; and
based on the clamp range, generating the transformed version of the ground truth version of the digital image by applying the color tune mapping function to the ground truth version of the digital image to transform pixel values in the ground truth version to match the color tune mapping function.

16. The system of claim 9, wherein the operations further comprise modifying parameters of the generative model based on comparing the transformed modified digital image with the transformed version of the ground truth version of the digital image, wherein the generative model comprises a generative adversarial neural network.

17. A computer-implemented method comprising:
receiving a request to inpaint a digital image;
generating, utilizing a generative model trained utilizing color space transformation to avoid generating inpainting artifacts, an inpainted digital image from the digital image by inpainting a region of the digital image; and
providing the inpainted digital image for display via a graphical user interface.

18. The computer-implemented method of claim 17, wherein receiving the request to inpaint the digital image comprises:
receiving a digital sketch over a region of the digital image; and
generating, utilizing a segmentation model, a mask for the region of the digital image from the digital sketch.

19. The computer-implemented method of claim 17, generating the inpainted digital image comprises:
receiving an indication to inpaint the region in the digital image, wherein the region is indicated by a mask; and
generating inpainted pixels to replace the region indicated by the mask in the digital image in a manner that reduces inpainting artifacts along a border of the region.

20. The computer-implemented method of claim 17, further comprising training the generative model utilizing the color space transformation by:
generating an amplified version of a training digital image by determining a difference in pixel values of the training digital image and a ground truth version of the training digital image and enhancing the difference in pixel values by an enhancement factor;
generating a color tune mapping function based on sampling pixel values from the training digital image and the amplified version of the training digital image;
generating a transformed training digital image and a transformed ground truth image of the training digital image by using the color tune mapping function; and
modifying parameters of the generative model based on comparing the training digital image with the ground truth version of the training digital image and comparing the transformed training digital image and the transformed ground truth image of the training digital image.
